(19) United States
(12) Patent Application Publication
(10) Pub. No.: US 2003/0090574 A1
(43) Pub. Date: May 15, 2003

(54) Systems and methods for providing automated delivery of digital images

(76) Inventors: Mark D. Seaman, Greeley, CO (US); Robert D. Thompson, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/002,675

(22) Filed: Oct. 30, 2001

(51) Int. Cl. H04N 5/225

(52) U.S. Cl. 348/207.99; 348/207.1

(57) ABSTRACT

Systems and methods for providing automated delivery of digital images, such as still images and/or video, from an image capture device to an image display device are provided. Briefly described, in architecture, one of many possible embodiments is an image capture device. The image capture device may comprise image capture hardware configured to capture an image, a network interface configured for communication with a communications network, and logic configured to generate a digital image comprising image data and configured to automatically provide the image data to the communications network for delivery to at least one specified display device.

### TECHNICAL FIELD

The present invention is generally related to digital images, and more specifically to systems and methods for providing automated delivery of digital images.

### BACKGROUND OF THE INVENTION

Presently, there are a variety of devices configured for capturing an image, such as a still image and/or a video image, and generating an electronic representation of the image. For instance, video recorders and similar devices are often used to capture video images. Digital cameras, image scanners, and other similar devices are customarily used to capture still images. Any of these devices are typically configured to enable the images to be stored as digital images on the device. These devices generally also enable users to preview the digital images. Such devices may also enable users to download the digital images by manually connecting the device to a personal computer where the digital images may be stored, edited, or transmitted via a communications network to other devices configured for connection to the communications network.

Typically, digital images may be viewed by a variety of image display devices configured for rendering and displaying the digital images, such as, for example, a personal computer (PC), a personal digital assistant (PDA), a WebTV® receiver, a network-enabled digital picture frame 126, such as a Cieva® Digital Picture Frame or a Kodak® Smart Picture Frame, and/or a printer to name a few. Thus, users are currently able to capture digital images and transmit them from a communications network to a variety of display devices. However, the current approaches are typically very time consuming and bothersome. When delivering captured images to a recipient (who may be the original user or another user), the user manually connects the image capture device to another device, such as a computer, and then downloads the image to the other device. The user can then use the computer to transmit the digital images to the image display device to be displayed.

### SUMMARY OF THE INVENTION

The present invention provides systems and methods for providing automated delivery of digital images, such as still images and/or video, from an image capture device to an image display device.

Briefly described, in architecture, one of many possible embodiments is an image capture device. The image capture device may comprise image capture hardware configured to capture an image, a network interface device configured for communication with a communications network, and logic configured to generate a digital image comprising image data and configured to automatically provide the image data to the communications network for delivery to at least one specified display device.

The present invention may also be viewed as providing a method for providing automated delivery of digital images. Briefly, one such method comprises the steps of: capturing an image; generating a digital image comprising image data of the captured image; and providing the image data to a communications network for delivery to an image delivery system.

Briefly, another such method comprises the steps of receiving automated image delivery information from an image capture device via a communications network, the automated image delivery information configured for determining an image display device to which a particular digital image is to be delivered; receiving image data related to a digital image from the image capture device via the communications network; determining, based on the automated image delivery information, the image display device to which the image data is to be delivered; and providing the image data to the communications network for delivery to the image display device.

The present invention may also be viewed as a system for automated delivery of digital images. Briefly described, one embodiment comprises: a means for receiving automated image delivery information from an image capture device via a communications network, the automated image delivery information configured for determining an image display device to which a particular digital image is to be delivered; a means for receiving image data related to a digital image from the image capture device via the communications network; a means for determining, based on the automated image delivery information, the image display device to which the image data is to be delivered; and a means for providing the image data to the communications network for delivery to the image display device.

Furthermore, the present invention may be viewed as providing an image delivery system for providing automated delivery of digital images. Briefly described, in architecture, one embodiment comprises a network interface device configured for communication with a communications network and logic configured to: receive from an image capture device, via the communications network, automated delivery information associated with the image capture device, the automated image delivery information configured for determining an image display device to which a particular digital image is to be delivered; receiving from the image capture device, via the communications network, image data related to a digital image; determining, based on the automated image delivery information, the image display device to which the image data is to be delivered; and providing the image data to the communications network for delivery to the image display device.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating a composite of several possible embodiments of a system for providing automated delivery of digital images according to the present invention.

FIG. 2 is a flow chart illustrating the general operation of the system of FIG. 1 according to the present invention.

FIG. 3 is a schematic diagram of an embodiment of the image delivery system of FIG. 1 according to the present invention.

FIG. 4 is a flow chart illustrating the architecture, operation, and/or functionality of an embodiment of the automated image delivery module in the image delivery system of FIG. 3 according to the present invention.

FIG. 5 is a schematic diagram of an embodiment of the image capture device of FIG. 1 according to the present invention.

FIG. 6 is a flow chart illustrating the architecture, operation, and/or functionality of an embodiment of the image delivery module of the image capture device of FIG. 5 according to the present invention.

### DETAILED DESCRIPTION OF A PREFERRED EMBODIMENT

I. System Overview

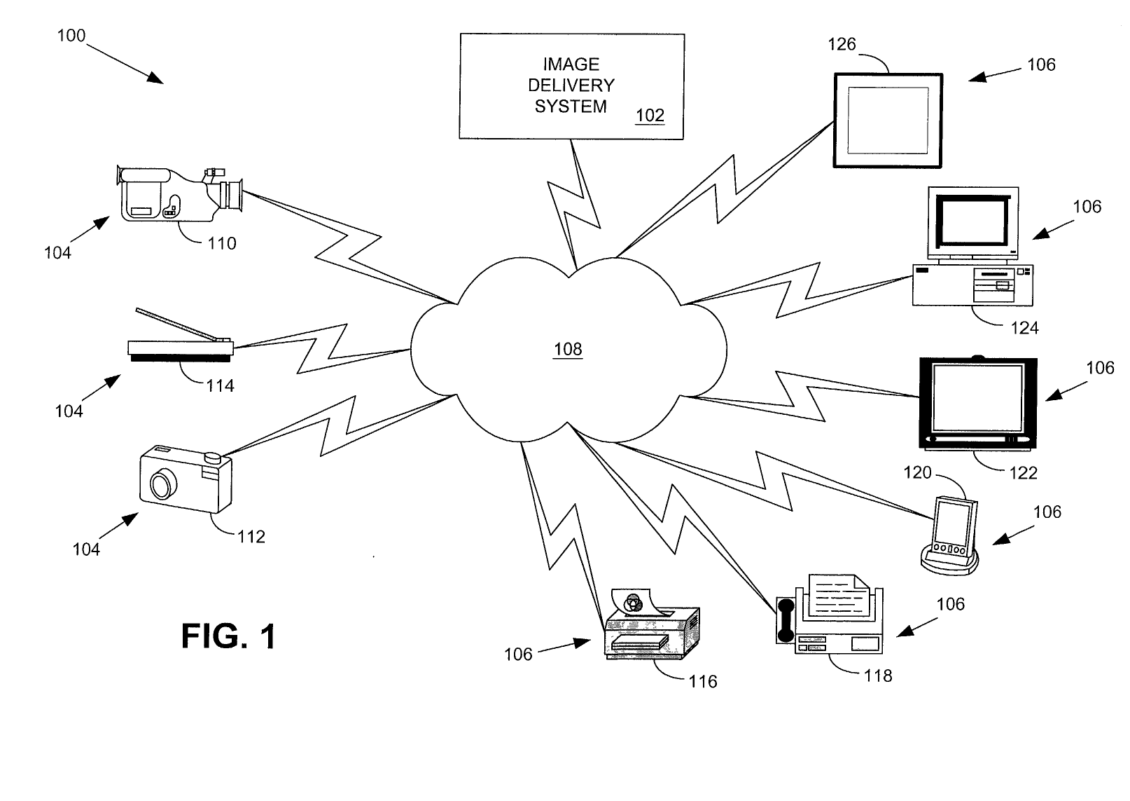

FIG. 1 illustrates a system 100 operable to provide automated delivery of digital images according to the present invention. System 100 may comprise an automated image delivery system 102, at least one image capture device 104, and at least one image display device 106 interconnected via communications network 108.

Communications network 108 may be any type of communications network employing any network topology, transmission medium, or network protocol. For example, communications network 114 may be a local area network (LAN), a metropolitan area network (MAN), a wide area network (WAN), any public or private packet-switched or other data network, including the Internet, circuit-switched networks, such as the public switched telephone network (PSTN), wireless networks, optical networks, or any other desired communications infrastructure.

Image capture device(s) 104 may be any of a variety of devices (1) configured for capturing images, such as still images and/or video images, and (2) configured for communication with communications network 108. For example, as illustrated in FIG. 1, and not by way of limitation, image capture device(s) 104 may be a video recorder 110 configured for communication with communications network 108, a camera 112, such as a digital camera, configured for communication with communications network 108, an image scanner 114 configured for communication with communications network 108, or any other similar device configured for capturing still images and/or video images and also configured for communication with communications network 108.

Image display device(s) 106 may be any of a variety of devices (1) configured for displaying images, such as still images and/or video images, and (2) configured for communication with communications network 108. For example, as illustrated in FIG. 1, and not by way of limitation, image display device(s) 106 may be a printer 1 10 configured for communication with communications network 108, a facsimile device 118, a personal digital assistant (PDA) 120 configured for communication with communications network 108, a television 122 configured for communication with communications network 108, such as a WebTV® receiver, a personal computer (PC) 124, a network-enabled digital picture frame 126, such as a Cieva® Digital Picture Frame or a Kodak® Smart Picture Frame, or any other similar device configured for displaying still images and/or video images and also configured for communication with communications network 108.

However, as will be appreciated by one of ordinary skill in the art, the precise configuration of communications network 108, image capture device(s) 104, and image display device(s). System 100 enables image capture devices 104 to provide digital images directly to communications network 108 for automated delivery by image delivery system 102 to any specified image display device 106.

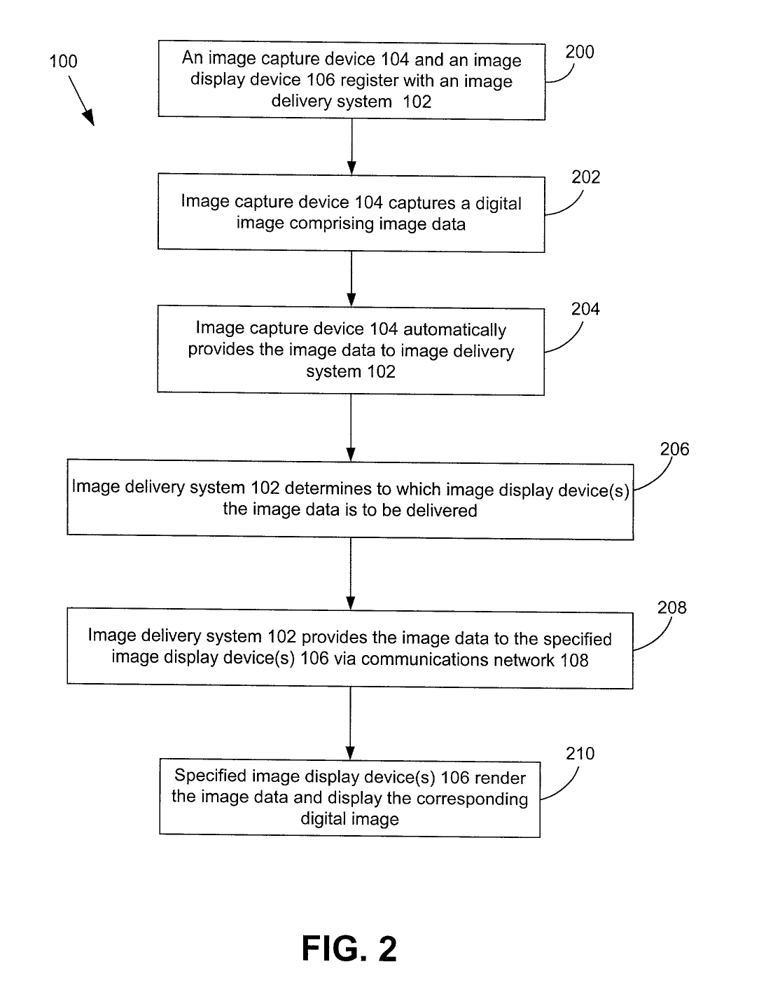

FIG. 2 is a flow chart illustrating the general operation of an embodiment of system 100 with respect to a single image capture device 104 and a single image display device 106. It will be appreciated by those skilled in the art that other embodiments of system 100 may comprise more than one image capture device 104 and/or more than one image display device 106 and still remain within the scope of the present invention. However, for ease of understanding the present invention, only one of each device will be discussed.

At block 200, image capture device 104 and image display device 106 preferably register with image delivery system 102. Image capture device 104 and image display device 106 may register with image delivery system 102 in a variety of ways. For instance, a user associated with an image capture device 104 or an image display device 106 may register with image delivery system 102 by entering into a services agreement with a service provider affiliated with image delivery system 102. For example, this may be accomplished at the time image capture device 104 and image display device 106 is purchased or any other time. During the registration process, image delivery system 102 may obtain various registration information related to any of the following: information related to the user, information related to the types of services desired by the user, information related to the type of image capture device 104 and image display device 106, or any other desirable data.

As described in detail below, during the registration process, image delivery system 102 may also obtain specific details about how and when image data received from image capture device 104 is to be delivered. For example, a user of an image capture device 104 may specify at least one image display device 106 to receive image data that is provided to image delivery system 102. The user may define specific categories of image data that are to be delivered only to specific image display device(s) 106. As understood by those of ordinary skill in the art, the user of an image capture device 104 may also customize any of numerous other aspects of the image delivery process. One of ordinary skill in the art will appreciate that the registration process may occur as direct communication between image capture device 104 and image display device 106 and image delivery system 102 via communications network 108.

Furthermore, as described in detail below, the information provided during the registration may vary depending on the particular configuration of, and services to be provided by, image delivery system 102 and image capture device 104. It is preferred that image delivery system 102 and image capture device 104 are configured so that when image delivery system 102 receives image data from image capture device 104, image delivery system 102 can automatically access sufficient information to determine which image display device(s) 106 are to receive the image data. Therefore, this information may be provided during the registration process, or, as described below, may be provided by image capture device 104 when the image data is provided directly to the communications network for delivery to image delivery system 102.

At block 202, image capture device 104 captures a digital image, which comprises image data. At block 204, image capture device 104 provides the image data directly to communications network 108 for delivery to a specified image display device 106. One of ordinary skill in the art will appreciate that the image data may be provided to communications network 108 in many ways. For example, the image data may be provided automatically after image capture, automatically after a predefined period of time, and with or without user input. As stated above, depending on the particular configuration of, and services to be provided by, image delivery system 102 and, depending on the information obtained during the registration process, image capture device 104 may provide a variety of additional types of information at block 204 in addition to providing the image data. For instance, in certain embodiments, image delivery system 102 may obtain information during the registration process related to which image display devices 106 are to receive image data provided to image delivery system 102 by image capture device 104. In these situations, at block 204, image capture device 104 may also provide identification data associated with image capture device 104. Based on the identification data associated with image capture device 104, image delivery system 102 may access a database to determine which image display device(s) 104 were specified during the registration process to receive image data from image capture device 104. As understood by one of ordinary skill in the art, this functionality may be performed in a variety of ways. For example, image delivery system 102 may employ a standard look-up table referenced by a unique identifier associated with each image capture device 104.

In other embodiments, image delivery system 102 may not obtain, during the registration process, the necessary information to determine which image display device(s) 106 are to receive the image data from a particular image capture device 104. In these situations, at block 204, image capture device 104 may provide, for example, identification data that identifies image display device(s) 106 to which the image data is to be delivered. It is preferable that image delivery system 102 and image capture device 104 are configured so that when image delivery system 102 receives image data from image capture device 104, image delivery system 102 has, or can automatically access, sufficient information to determine which image display device(s) 106 are to receive the image data. For instance, this information may be provided at block 200 during the registration process, at block 204 when the image data is provided directly to the communications network 108 for delivery to image delivery system 102, or in any combination thereof.

Image delivery system 102 receives the image data provided by image capture device 104 directly to communications network 108. At block 206, image delivery system 102 determines to which image display device(s) 106 the image data is to be delivered. Depending on the particular configuration of image delivery system 102, this functionality may be performed in a variety of ways. For instance, where image capture device 104 provides identification data associated with image capture device 104, image delivery system 102 may access a database to determine which image display device(s) 104 were specified during the registration process to receive image data from image capture device 104. In other situations, which image display device(s) 106 are to receive the image data may be contained in the identification data provided by image capture device 104.

At block 208, image delivery system 102 provides the image data to the specified image display device(s) 106 via communications network 108. At block 210, the specified image display device(s) 106 may render the image data and display the corresponding digital image.

II. Image Delivery System

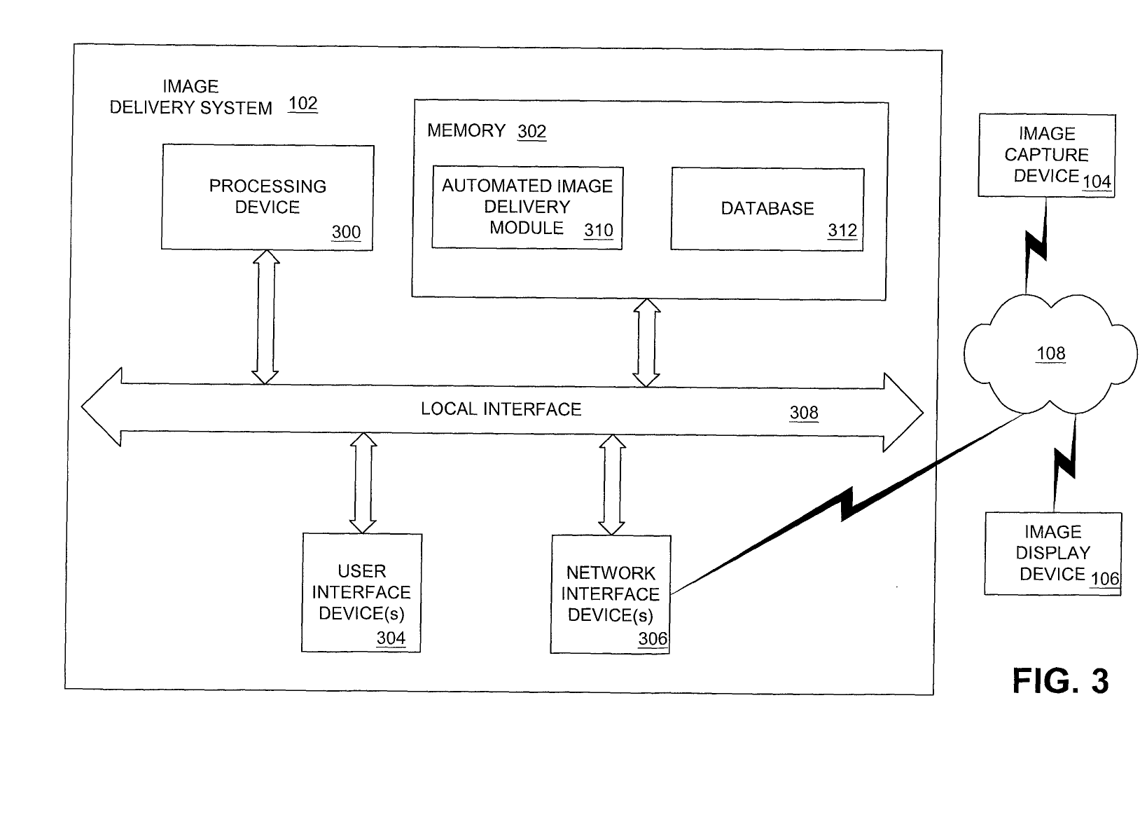

FIG. 3 illustrates a schematic diagram of one of a number of possible embodiments of image delivery system 102 of FIG. 1. Image delivery system 102 may comprise a processing device 300, memory 302, one or more user interface devices 304, and one or more network interface devices 306 interconnected via local interface 308. Memory 302 may comprise an automated image delivery module 310 and a database 312. As understood by one of ordinary skill in the art, image delivery system 102 may further comprise any of a number of other components not illustrated in FIG. 3. In certain embodiments, image delivery system 102 may be implemented as a network device, such as a server, configured as described above. However, one of ordinary skill in the art will appreciate that there are numerous other embodiments for image delivery system 102.

Local interface 308 may be, for example but not limited to, one or more buses or other wired or wireless connections, as known in the art. Local interface 308 may comprise additional elements, which are omitted for simplicity, such as controllers, buffers (caches), drivers, repeaters, and receivers, to enable communications. Further, local interface 308 may include address, control, and/or data connections to enable appropriate communications among processing device 300, memory 302, network interface devices 306 and user interface devices 304.

Memory 302 may include any one or combination of volatile memory elements (e.g., random access memory (RAM, such as DRAM, SRAM, SDRAM, etc.)) and nonvolatile memory elements (e.g., ROM, hard drive, tape, CDROM, etc.). Memory 302 may incorporate electronic, magnetic, optical, and/or other types of storage media. Memory 302 may also have a distributed architecture, where various components are situated remote from one another, but may be accessed by the processing device 300. Memory 202 may comprise an automated image delivery module 310 and a database 312.

Processing device 300 may be a hardware device for executing software located in memory 302. Processing device 300 may be any custom made or commercially available processor, a central processing unit (CPU), a semiconductor based microprocessor (in the form of a microchip or chip set), a macroprocessor, or generally any device for executing software instructions.

User interface device(s) 306 may comprise one or more devices configured to enable a user to interact with image delivery system 102. User interface device(s) 306 may also comprise a computer monitor or other similar display for facilitating the interaction between the user and image delivery system 102. As understood by one of ordinary skill in the art, image delivery system 102 may further comprise any of a number of other components not illustrated in FIG. 3.

Network interface device(s) 308 may be configured to facilitate communication with image capture device 104, image display device 106, and any other device connected to communications network 106. Thus, network interface device(s) 308 may comprise a data transmitting device and a data receiving device for providing wired and/or wireless communication between image delivery system 102 and communication network 106.

Automated image delivery module 310 may be implemented in hardware, software, firmware, or a combination thereof. As illustrated in FIG. 3, in one of a number of possible embodiments, automated image delivery module 310 is implemented in software or firmware that is stored in memory 302 and executed by processing device 300 or any other suitable instruction execution system. If implemented in hardware, as in alternative embodiments, automated image delivery module 310 may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

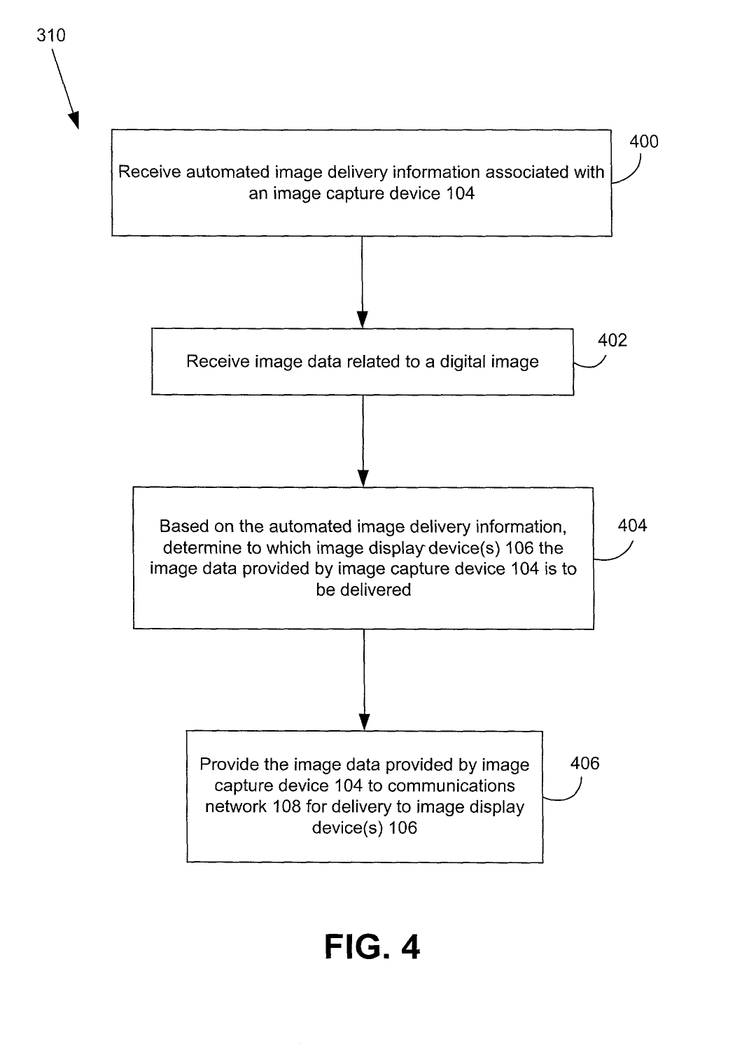

FIG. 4 is a flow chart illustrating the architecture, operation, and/or functionality of one of a number of possible embodiments of automated image delivery module 310 of FIG. 3. At block 400, automated image delivery module 310 receives automated image delivery information associated with an image capture device 104. The automated image delivery information may be configured for enabling automated delivery module 310 to determine which image display device(s) 106 are to receive image data provided by image capture device 104. At block 402, automated image delivery module 310 receives image data related to at least one digital image provided by image capture device 104 to communications network 108. At block 404, automated image delivery module 310 determines, based on the automated image delivery information, which image display device(s) 106 are to receive the image data provided by image capture device 104. At block 406, automated image delivery module 310 may provide the image data to communications network 108 for delivery to image display device(s) 106.

III. Image Capture Device

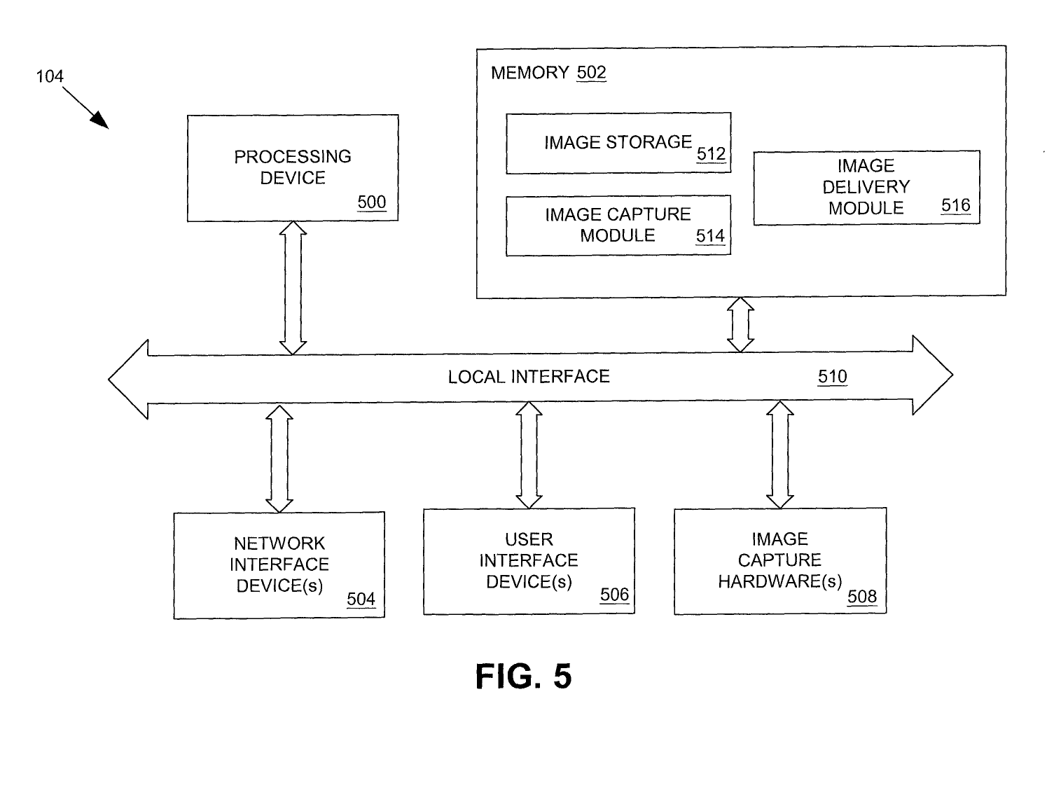

As stated above, image capture devices 104 may be any of a variety of devices configured for capturing images, such as still images and/or video images, and also configured for communication with communications network 108. FIG. 5 illustrates a schematic diagram of one of a number of possible embodiments of image capture device 104 according to the present invention. Image capture device 104 may comprise a processing device 500, memory 502, one or more network interface devices 504, one or more user interface devices 506, and image capture hardware 508 interconnected via local interface 510. Memory 502 may comprise image storage 512, an image capture module 514, and an image delivery module 516.

Local interface 510 may be, for example but not limited to, one or more buses or other wired or wireless connections, as known in the art. Local interface 510 may comprise additional elements, which are omitted for simplicity, such as controllers, buffers (caches), drivers, repeaters, and receivers, to enable communications. Further, local interface 510 may include address, control, and/or data connections to enable appropriate communications among processing device 500, memory 502, network interface devices 504, user interface devices 506, and image capture hardware 508.

Memory 502 may include any one or combination of volatile memory elements (e.g., random access memory (RAM, such as DRAM, SRAM, SDRAM, etc.)) and nonvolatile memory elements (e.g., ROM, hard drive, tape, CDROM, etc.). Memory 502 may incorporate electronic, magnetic, optical, and/or other types of storage media. Memory 502 may also have a distributed architecture, where various components are situated remote from one another, but may be accessed by the processing device 500. Memory 502 may comprise image storage 512, image capture module 514, and image delivery module 516.

Processing device 500 may be a hardware device for executing software located in memory 502. Processing device 500 may be any custom made or commercially available processor, a central processing unit (CPU), a semiconductor based microprocessor (in the form of a microchip or chip set), a macroprocessor, or generally any device for executing software instructions.

User interface device(s) 506 may comprise one or more function keys with which the operation of the image capture device 104 can be controlled by a user. User interface device(s) 506 may also comprise a liquid crystal display (LCD) or other similar display for facilitating the interaction between a user and image capture device 104. Furthermore, user interface device(s) 506 may comprise a display for previewing the images captured by the device. Image capture hardware 508 may comprise the components for capturing an image, generating a digital representation of the image, and storing the image data in image database 512. As understood by one of ordinary skill in the art, image capture device 104 may further comprise any of a number of other components not illustrated in FIG. 5.

Network interface device(s) 508 may be configured to facilitate communication with image delivery system 102 or any other device connected to communications network 108. Thus, network interface device(s) 508 may comprise a devices for providing wired and/or wireless communication between image capture device 104 and communications network 108.

Image capture module 514 and image delivery module 516 may be implemented in hardware, software, firmware, or a combination thereof. As illustrated in FIG. 5, in one of a number of possible embodiments, image capture module 514 and image delivery module 516 are implemented in software or firmware that is stored in memory 502 and that is executed by processing device 500 or any other suitable instruction execution system. If implemented in hardware, as in alternative embodiments, image capture module 514 and image delivery module 516 may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Image capture module 514 comprises logic configured to cooperate with image capture hardware 508 for capturing an image, generating a digital representation of image, and storing the image data in image database 512. Image capture module 514 may also comprise logic configured for displaying and/or manipulating the image data, as well as other logic for performing any of a variety of other functions associated with image capture device 104.

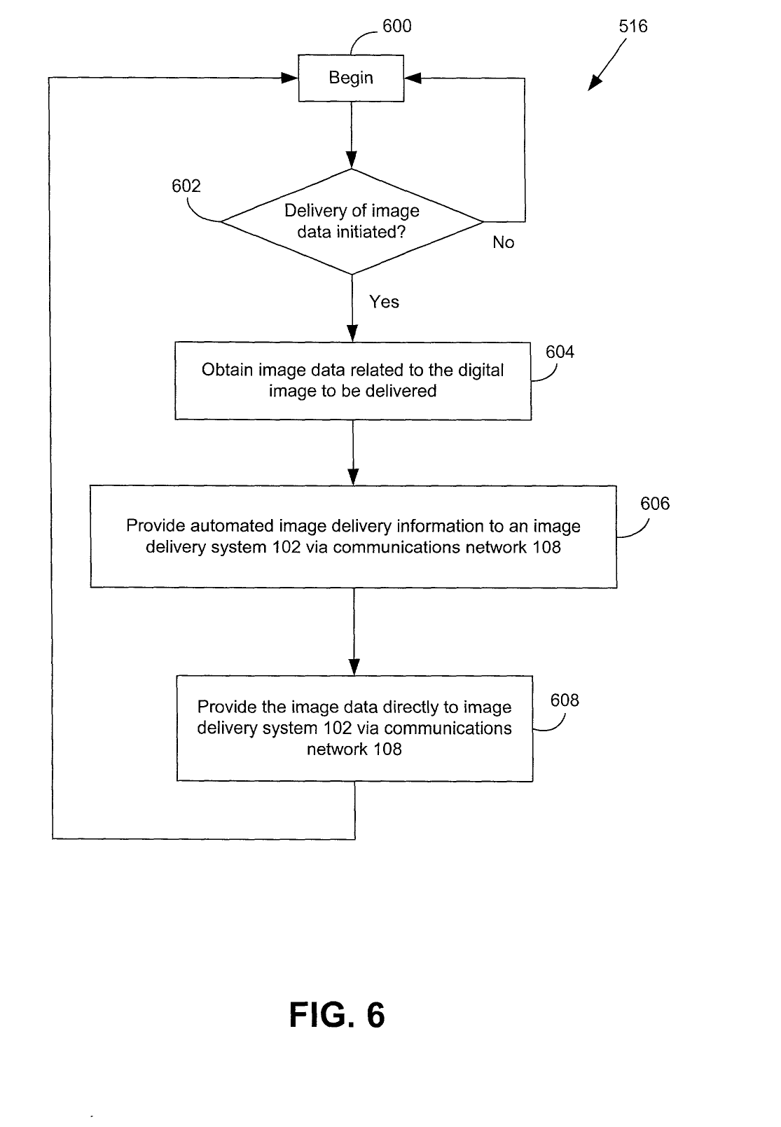

FIG. 6 is a flow chart illustrating the architecture, operation, and/or functionality of one of a number of possible embodiments of image delivery module 516 of FIG. 5. After beginning at block 600, at decision block 602, image delivery module 516 determines whether delivery of image data related to a digital image has been initiated. Delivery of image data may be initiated in a variety of ways. For instance, image capture device 104 may be configured so that delivery is automatically initiated at specific times or is automatically initiated after an image is captured. Image capture device 104 may also be configured so that delivery is initiated by a user via user interface device 506. In other embodiments, delivery of image data may be initiated by image delivery system 102.

Regardless how delivery is initiated, at block 604, image delivery module 516 obtains the image data to be delivered. At block 606, image delivery module 516 provides automated image delivery information to image delivery system 102 via communications network 108 for subsequent delivery to the specified image display device(s) 106. The automated image delivery information may comprise data configured for use by image delivery system 102 to determine to which image display device(s) 106 the image data is to be delivered. At block 608, image delivery module 516 provides the image data to image delivery system 102 via communications network 108 for subsequent delivery to the specified image display device(s) 106.

Image delivery module 516 and automated image delivery module 310, which each comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Therefore, having thus described the invention, at least the following is claimed:

1. An image capture device comprising:
image capture hardware configured to capture an image;
a network interface device configured for communication with a communications network; and
logic configured to generate a digital image of the captured image comprising image data and configured to automatically provide the image data to the communications network for delivery to at least one specified display device.

2. The image capture device of claim 1, wherein the at least one specified display device is specified prior to generating the digital image.

3. The image capture device of claim 1, wherein the logic is software stored in a memory and further comprising a processor device for implementing the logic.

4. The image capture device of claim 1, wherein the logic is further configured to provide automated image delivery information to the communications network for delivery to an image delivery system in communication with the communications network, the automated image delivery information comprising data configured for use by the image delivery system to determine the at least one specified image display device to which the image data is to be delivered.

5. The image capture device of claim 1, wherein the image capture hardware is configured to scan the image.

6. The image capture device of claim 1, wherein the image capture hardware comprises one of a digital camera, a scanner, a WebTV® receiver, a digital picture frame, and a video recorder..

7. The image capture device of claim 4, wherein the automated image delivery information further comprises identification data associated with the image capture device, the identification data configured to be used by the image delivery system to identify the image capture device.

8. An image capture device comprising:
means for capturing an image;
means for generating a digital image of the captured image, the digital image comprising image data;
means for communicating with a communications network; and
means for automatically providing the image data directly to the communications network for delivery to at least one specified display device.

9. The image capture device of claim 8, further comprising a means for providing automated image delivery information to the communications network for delivery to an image delivery system in communication with the communications network, the automated image delivery information comprising data configured for use by the image delivery system to determine the at least one specified image display device to which the image data is to be delivered.

10. A method for providing automated delivery of digital images, the method comprising the steps of:
capturing an image;
generating a digital image of the captured image, the digital image comprising image data;
providing the image data to a communications network for delivery to an image delivery system.

11. The method of claim 10, further comprising providing automated image delivery information to the communications network for delivery to the image delivery system, the automated image delivery information comprising data configured to enable the image delivery system to determine at least one image display device to which the image data is to be delivered.

12. The method of claim 11, wherein the automated image delivery information further comprises identification data associated with the image capture device, the identification data configured to enable the image delivery system to identify the image capture device.

13. A method for providing automated delivery of digital images, the method comprising the steps of:
receiving automated image delivery information associated with an image capture device, the automated image delivery information configured for determining an image display device to which a particular digital image is to be delivered;
receiving image data related to a digital image, the image data provided by the image capture device to the communications network;
based on the automated image delivery information, determining the image display device to which the image data is to be delivered; and
providing the image data to the communications network for delivery to the image display device.

14. The method of claim 13, wherein the automated image delivery information includes identification data associated with the image capture device, the identification data configured for enabling identification of the image capture device

15. A system for providing automated delivery of digital images, the system comprising:
means for receiving automated image delivery information from an image capture device via a communications network, the automated image delivery information configured for determining an image display device to which a particular digital image is to be delivered;
means for receiving image data related to a digital image from an image capture device via the communications network;
means for determining, based on the automated image delivery information, the image display device to which the image data is to be delivered; and
means for providing the image data to the communications network for delivery to the image display device.

16. The system of claim 15, wherein the automated image delivery information further comprises identification data associated with the image capture device, the identification data configured to identify the image capture device.

17. An image delivery system for providing automated delivery of digital images, comprising:
a network interface device configured for communication with a communications network; and
logic configured to:
receive from an image capture device, via the communications network, automated image delivery information associated with the image capture device, the automated image delivery information configured for determining an image display device to which a particular digital image is to be delivered;
receiving from the image capture device, via the network, image data related to a digital image;
determining, based on the automated image delivery information, the image display device to which the image data is to be delivered; and
providing the image data to the communications network for delivery to the image display device.

18. The image delivery system of claim 17, wherein the logic is software stored in a memory and further comprising a processor device for implementing the logic.

19. The image delivery system of claim 17, wherein the automated image delivery information includes identification data associated with the image capture device, the identification data identifying the image capture device.
